(19) United States
(12) Patent Application Publication
(10) Pub. No.: US 2012/0116873 A1
(43) Pub. Date: May 10, 2012

(54) Network Traffic Redirection And Conversion Tracking

(75) Inventors: Michael Damm, San Francisco, CA (US); Kamal Ravikant, San Francisco, CA (US)

(73) Assignee: REVNETICS, INC., San Francisco, CA (US)

(21) Appl. No.: 13/022,980

(22) Filed: Feb. 8, 2011

Related U.S. Application Data
(60) Provisional application No. 61/410,789, filed on Nov. 5, 2010.

(51) Int. Cl. G06Q 30/00; G06F 15/173

(52) U.S. Cl. 705/14.49; 709/240; 705/27.1

(57) ABSTRACT

Network traffic associated with a set of domain names is redirected according to campaigns provided by one or more potential purchasers of network traffic. The campaigns include a set of preferences for the network traffic a campaign targets. Individual requests for a domain in the set of domain names are analyzed to determine a set of request attributes. The set of request attributes are compared with the sets of preferences provided by the potential purchasers. The traffic is redirected according to the campaigns provided by purchasers. Network traffic for a set of domain names can be auctioned or otherwise sold in real-time based on campaigns provided by potential purchasers. Conversion tracking may provided independently or in combination with redirecting network traffic according to campaigns.

### PRIORITY CLAIM

The present application claims priority from U.S. Provisional Patent Application No. 61/410,789, entitled “Network Advertising Platform,” by Damm, et al., filed Nov. 5, 2010, which is incorporated by reference herein in its entirety.

### BACKGROUND

Embodiments in accordance with the present disclosure relate to computer networks, and more particularly to traffic redirection and tracking in computer networks.

Network-based advertising such as that found on the internet has traditionally included three distinct channels. Advertising in the search channel typically involves a search engine provider providing advertising on web pages displaying a user's search results. The advertising results may include links to an advertiser's web site for example. Monetization in the search channel typically includes advertisers paying the search provider for displaying advertisements and/or for visitor selections of advertising links.

Advertising in the display channel typically involves the owner of a web site or a third-party advertiser providing ads on the owner's web site. Similar to search channel advertising, monetization in the display channel typically involves advertisers paying a web site owner for displaying advertisements and/or for visitor selections of advertising links.

Advertising in the domain channel typically involves domain name owners providing generic web pages with advertising links when particular domain names are requested. Domain names are alphanumeric name-based addresses that allow users to more easily locate and remember the addresses for network resources, which are actually addressed using Internet Protocol (IP) addresses comprised of a quartet of numeric values. The domain name system (DNS) facilitates the translation between IP addresses and domain names by maintaining accessible records that associate one or more domain names with one or more IP addresses. Domain channel advertising typically focuses on unused or underutilized domain names, having somewhat recognizable or familiar words, phrases or expressions. Unused or underutilized domain names are those that are not traditionally used to identify a specific network resource or set of network resources. Typically, an unused or underutilized domain name is used to provide advertising links on a generic web page with little or no actual content. This practice is often referred to as parking a domain name to present parked domains or web pages.

### SUMMARY OF THE INVENTION

Embodiments of the present disclosure are directed to computer network-based traffic redirection and conversion tracking Network traffic associated with a set of domain names is redirected according to campaigns provided by one or more potential purchasers of the network traffic. The campaigns include a set of preferences for the network traffic a particular purchaser may wish to target. Individual requests associated with a domain in the set of domain names are analyzed to determine a set of request attributes. The set of request attributes are then compared with the sets of preferences provided by the potential purchasers of the traffic. The traffic is redirected according to the advertising campaigns provided by the purchasers. Redirecting the traffic may include redirecting traffic to a network resource specified by a purchaser, directing the traffic to the resource originally requested, or redirecting the traffic to a resource specified by an alternate monetization option. In one embodiment, network traffic for a set of domain names is auctioned or otherwise sold in real-time based on advertising campaigns provided by potential purchasers of that traffic.

Conversion tracking may also be provided in combination with or independently of redirecting traffic according to campaigns. A visitor may initiate a request at a client device that is associated with acquisition of an application. The request is received at a first server, which responds to the client device with a URL redirect to a second server where the application may be acquired. The client device issues a request to the second server. If the application is acquired, the application registers itself at the client device as the default application for a unique URL handler. Upon execution, the application redirects the client device back to the first server. The first server receives the request and determines whether the unique identifier is present. If the unique identifier is present, the first server can store an indication that the first request was converted into an acquisition of the application. The first server then provides a URL redirect to the client device with the unique URL handler, which will cause the application to again execute at the client device, thus providing a seamless tracking of the conversion.

A computer-implemented method of directing network traffic associated with a set of domains is provided in one embodiment that includes determining a set of request attribute values for each request in network traffic associated with a plurality of domain names. Each set of request attribute values is compared to a plurality of campaigns. Each campaign includes a plurality of campaign filter values. One or more campaigns for each request in the network traffic is selected based on comparing the set of request attribute values for each request to the plurality of campaigns. Each request in the network traffic is redirected according to at least one redirect resource specified by the one or more selected campaigns. The specification of a redirect resource may include a resource locator. The requests may be redirected by providing a resource locator redirect to the redirect resource.

A computer-implemented method of controlling network traffic in one embodiment includes receiving from a client device a network request associated with a first domain name in a set of aggregated domain names. The method includes determining from a plurality of redirect resources a first redirect resource based on a set of request attribute values for the network request. A resource locator for the first redirect resource is associated with a second domain name. The first redirect resource associated with the second domain name is returned to the client device in response to the network request associated with the first domain name.

A computer-implemented method for conversion tracking in one embodiment includes receiving from a first application at a client device a first network request associated with acquisition of a second application. The first network request is received at a first server. A unique identifier is provided to the client device and the client device is redirected to a second server in response to the network request. The second server provides access to the second application. A second network request is received at the first server from the second application at the client device that is associated with acquisition of the second application. It is determined, in response to the second network request, if the second network request includes the unique identifier. A resource locator having a handler associated with the second application is provided to the client device in response to the second network request.

Corresponding methods, systems and computer- or processor-readable storage devices which include a storage media encoded with instructions which, when executed, perform the methods provided herein, may be provided. Other features, aspects, and objects of the disclosed technology can be obtained from a review of the specification, the figures, and the claims.

### BRIEF DESCRIPTION OF THE DRAWINGS

FIG. 1 is a block diagram of a computer network including an redirect and tracking platform for redirecting network traffic according to advertising campaigns.

FIG. 2 is a block diagram of a computer network including an redirect and tracking platform and remote web hosting of domains having traffic directed by the redirect and tracking platform.

FIG. 3 is a flowchart describing a method of processing network traffic based on advertising campaigns.

FIG. 4 is a block diagram depicting an example of a set of advertising campaign filters.

FIG. 5 is a block diagram depicting an example of a set of request attribute values.

FIG. 6 is a flowchart describing a method of aggregating network traffic for a set of domain names.

FIG. 7 is a flowchart describing a method of creating an advertising campaign.

FIG. 8 is a flowchart describing a method of auctioning network traffic.

FIG. 9 is a flowchart describing a method of redirecting visitor requests for domains in a set of domains according to advertising campaigns.

FIG. 10 is a flowchart describing a method of returning responses to visitor requests in the aggregated network traffic.

FIG. 11 is a flowchart describing a method of automatically modifying advertising campaign filters.

FIG. 12 is a flowchart describing a method of providing recommendations for purchasing network traffic.

FIG. 13 is a flowchart describing a process for redirecting to a networked application store while providing conversion tracking in accordance with one embodiment.

FIG. 14 is a flowchart describing a process of conversion tracking in accordance with one embodiment.

FIG. 15 is a simplified block diagram of a computing device that can be used to implement various embodiments of the disclosed technology.

### DETAILED DESCRIPTION

In accordance with one embodiment of the presently disclosed technology, targeted advertising in the domain name channel is provided by redirecting traffic associated with a set of domain names to network resources based on attributes associated with individual requests. A redirect and tracking platform includes an interface and a redirect engine for routing domain name requests, including the redirection of individual requests based on their particular attributes. In one embodiment, auctions are created for individual domain name requests based on electronic advertising campaigns. A set of campaign filters is provided with advertiser values for one or more of the filters to indicate targeted attributes of requests associated with the set of domain names. The targeted attributes may include targeted visitor attributes, domain attributes and geographic attributes. Likewise, request attributes may include visitor attributes, domain attributes and geographic attributes.

Network traffic associated with a set of domain names is parsed to determine a set of request attributes and/or values for each request. The network traffic is then redirected based on the advertising campaigns. The attribute information is passed through the set of filters to develop a set of attribute values including visitor, domain and geographic attributes of the request. The set of attribute values is compared with the attribute values in each advertising campaign to identify any matching campaigns. An auction can be generated for requests having one or more matching campaigns. The request is auctioned to the campaign having the highest bid value in one example. Other criteria in addition to or in place of the highest bid value may be used to choose a campaign for redirecting a visitor request. The traffic is redirected to one or more network resources identified by one or more winning campaigns. If a single advertising campaign matches a particular request, the traffic can be redirected according to the single matching campaign, with or without creating an auction. Other variables such as determining whether a winning campaign meets a minimum bid amount specified by the owner of the requested domain can be considered in determining whether to redirect the visitor request.

Redirect resources are specified by the owner of each advertising campaign. The redirect resource may specify redirection of the visitor to a network resource owned or administered by the campaign owner. In one embodiment, the campaign owner specifies a web site as the network resource to which the visitor is redirected. Redirect resources are not limited to web sites, but may include any available network service. For example, other redirect resources may include redirect actions such as launching applications at the visitor's client device to initiate a phone call or short messaging service (SMS) message identified by the campaign owner, or launching an application for purchasing a product offered by the campaign owner. Resources can be specified or identified using any suitable resource locator such as a uniform resource locator (URL).

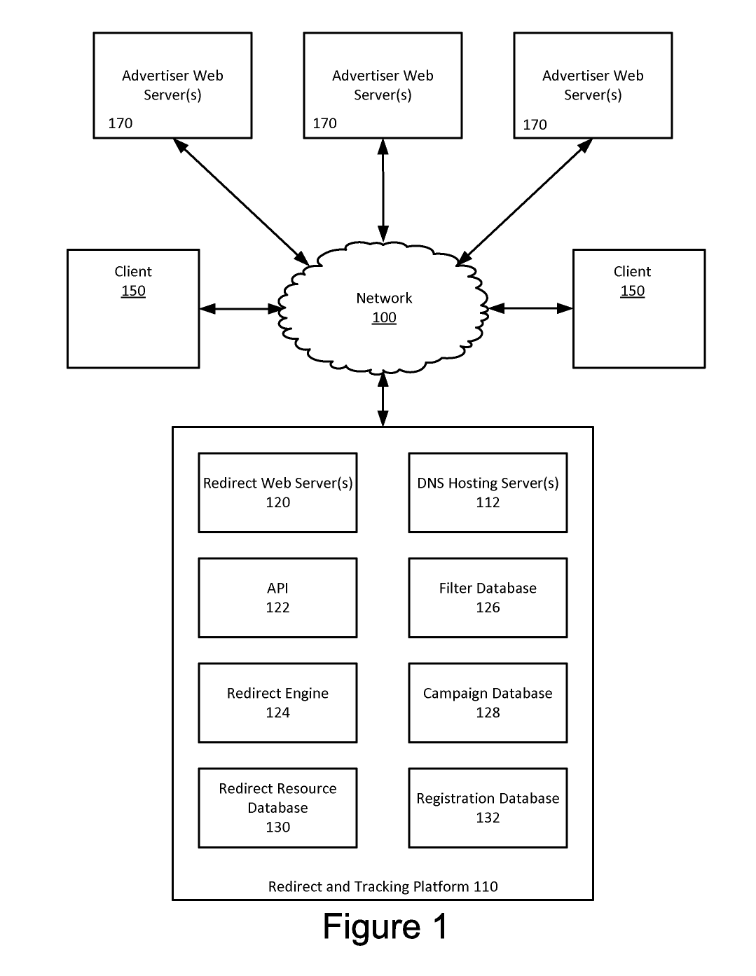

FIG. 1 is a block diagram depicting one embodiment of the presently disclosed technology. Advertiser web servers 170, redirect and tracking platform 110, and client devices 150 are each in communication with a communications network 100, such as the Internet. Network 100 may include any combination of public networks, private networks, corporate networks, local area networks (LAN), wide area networks (WAN) and the like. Although principally described with respect to the internet and web-based applications, embodiments in accordance with the present disclosure may be implemented in any type of computer network environment. Platform 110 processes requests from client devices 150 for network resources associated with a set of domain names by redirecting the requests to alternate network resources according to advertiser 170 campaigns and the attributes of individual visitor requests.

The redirect and tracking platform 110 includes one or more domain name system (DNS) hosting servers 112 and one or more web servers 120. The DNS hosting servers 112 include authoritative name servers that maintain an authoritative or master list of domain name to IP address mappings for a zone or group of computing devices. In this example, the authoritative name servers contain the authoritative mapping of a set of domain names to web servers 120.

Network traffic for a set of domain names is pooled or aggregated by platform 110 and designated for potential auction and transfer to potential advertising purchasers 170. DNS requests for any domain name in the set can be routed by the DNS system to an authoritative name server 112 in the redirect and tracking platform, which provides a DNS response with the IP address of one of the web servers 120. The client device eventually issues a request for a resource, such as a web page coded in html, to a web server 120 on the redirect and tracking platform 110. As will be described hereinafter, the redirect and tracking platform may also accept requests from remote web hosts for a redirect resource from a purchasing advertiser and/or a bid amount for redirect of a particular visitor request. Requests, including packets, cells, messages, and/or signals can include any requests for network resources. A request may include a Uniform Resource Locator (URL). Requests and redirects in accordance with embodiments can be implemented using any suitable protocol. Any protocol that supports redirects, which include a response from one server to redirect a client to another server to receive service, can be used.

A visitor's resource request for or otherwise associated with a domain in the set of domain names pooled by platform 110 is redirected to a resource specified by one of the advertisers 170 according to an auction of the individual visitor request. Advertisers 170 operate one or more web servers hosting resources to which they seek to redirect internet traffic, such as a web page, application, application store, etc. A set of campaign filters is provided in filter database 126 to enable advertisers to sort or otherwise filter traffic directed to the set of domains and bid on a redirection of particular visitor requests to resources on servers 170. The set of campaign filters correspond to potential request attributes that an advertiser may want to target. Advertisers establish a campaign with one or more campaign filter values associated with their targeted request attributes. The advertisers establish one or more bids for each campaign, representing an offered price for each visitor redirect, although other bid options may be used. The advertiser further provides an indication of a redirect resource representing an alternate network resource including locations, actions or other services to which visitor requests matching the campaign should be directed. These campaigns are then stored in campaign database 128.

The redirect web server 120 responds to a request for a domain in the set by passing the request to redirect engine 124 using application programming interface (API) 122. The visitor request may be a direct link request in one example, originating from an address directly supplied by the visitor (e.g., by typing an address in an address bar of a web browser). The visitor request may also be the result of linking (e.g., hyperlinking) from another resource or site, such as a link provided in a search results page or on another type of web page, or in the content provided by some other resource such as a game, application or the like.

The redirect engine parses the visitor request to obtain request attribute information, including visitor attributes, domain attributes and geographic attributes. The attribute information is passed through the set of campaign filters specified in the filter database 126 to obtain a set of request attribute values. The redirect engine then compares the set of request attribute values with the campaign filter values of individual campaigns in campaign database 128.

If a single campaign matches the set of request attribute values, the redirect engine determines the corresponding redirect resource for the matching campaign from the redirect resource database 130. The redirect resource refers to any network resource specified by an advertising campaign for redirecting visitor requests associated with a domain name in the set of domain names. Redirecting a visitor request may include directing the visitor or the traffic associated with a visitor to an alternate network resource not specified by the visitor's request.

An indication of the redirect resource is passed to the redirect web server 120 through API 122. The redirect web server 120 responds to the visitor request by providing the indication of the redirect resource to the client device 150, such as by redirecting the client device using a URL identified by the winning campaign. An HTTP response including a URL redirect to the appropriate advertiser 170 is provided in one example. A response can also include a packet, cell, message, or signal used for transmitting resource location information. A Uniform Resource Locator (URL) typically identifies resources available through network hosts. Some examples of URLs are http—HTTP resources, https—HTTP over SSL, ftp—File Transfer Protocol, mailto—E-mail address, ldap—Lightweight Directory Access Protocol lookups, file—resources available on the local computer or over a local file sharing network, news—Usenet newsgroups, gopher—the Gopher protocol, telnet—the TELNET protocol, and data—the Data: URL scheme for inserting small pieces of content in place. Typically, a URL includes domain names that form a portion of the URL.

In the above example, the redirect engine and API run or are otherwise provided by the redirect web server(s). In other implementations, the redirect and tracking platform may include additional servers that host the redirect engine and API, rather than hosting those applications on the web server(s). Any number of web-servers or backend servers, for example, can be used to implement the described platform.

Reference to advertisers is intended in the broadest sense to refer to any potential purchaser of network traffic. Advertisers may include individual entities, collective entities, owners or agents and the like. Although shown as operating web servers 170 in FIG. 1, the advertisers need not host or otherwise control the resource to which their purchased traffic is directed. For example, advertisers may specify redirection of a visitor request to an application on the visitor's client device in one example, representing the redirection to a resource not directly controlled by the advertiser.

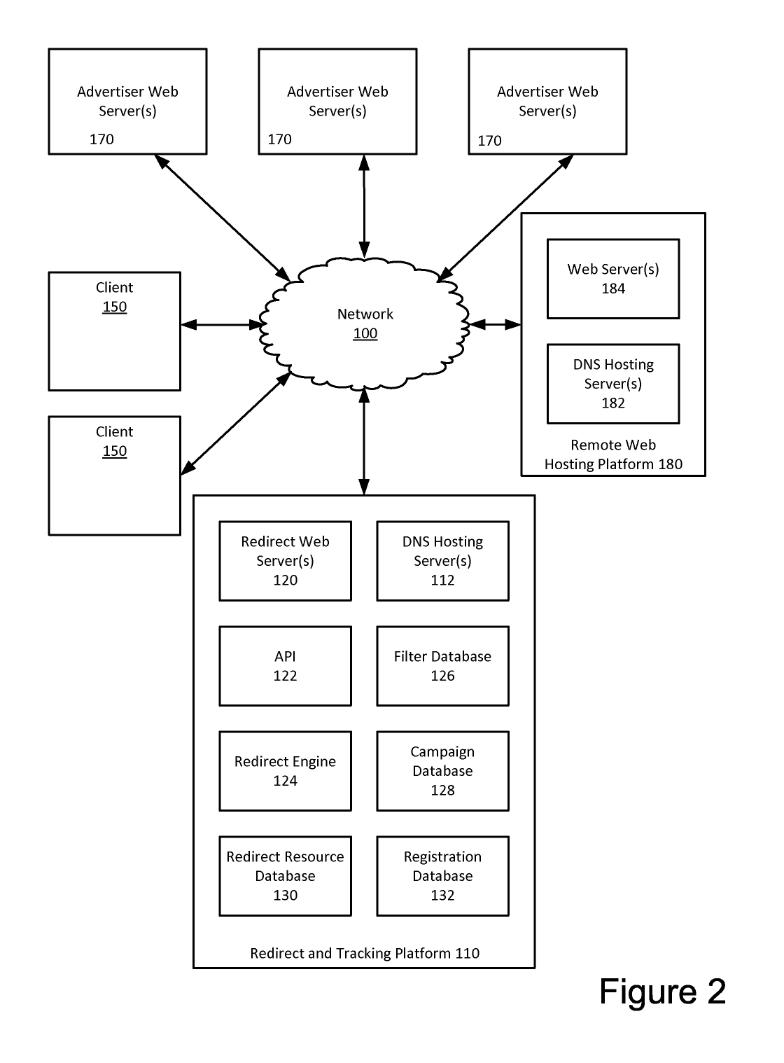

FIG. 2 depicts a further embodiment including the management and auction of traffic associated with domain names hosted outside of the redirect and tracking platform 110. Again, advertiser web servers 170, redirect and tracking platform 110 and client devices 150 are in communication over network 100. Additional remote web hosting platforms 180 are also in communication over network 100. Web hosting platforms 180 include one or more DNS hosting servers 182 maintaining an authoritative or master list of domain name to IP address mappings for a set of domains hosted by web servers 184. In application, the web hosting platform may be operated by an owner of a large group of domain names. In another example, the web hosting platform may be operated by an agent for multiple domain name owners. In some cases, such an owner may provide parked web pages primarily including sponsored listings based on the requested domain name. These parked pages may be provided by the owner, directly from web servers 180, or by passing or otherwise forwarding domain requests to a third party providing the web page content including sponsored listings. It is noted that the owner need not operate the web and/or DNS hosting servers directly. For example, the owner may delegate hosting and DNS hosting services to a third party. In this manner, the term owner is intended in its broadest sense to refer to any owner, controller, agent, aggregator or the like of domain names.

In FIG. 2, the client device first issues a DNS request for a domain name operated by one of the remote web servers 184. The request eventually resolves to and is received at one of the DNS hosting servers 182. The DNS hosting servers will direct the client device to one of the owner web servers 184 mapped to the requested domain name. The client device issues its resource request to the appropriate web server 184. In response to the resource request, the owner web server calls the redirect engine 124, passing the domain name request using API 122. In other examples, the remote web server may parse the request for request information and pass the information or a subset thereof to the redirect and tracking platform using API 122.

Like a request originating at the redirect and tracking platform as in FIG. 1, the redirect engine parses the request and passes it through a set of filters to obtain a set of request attribute values. The request attribute values are then compared with a set of filter values specified in the advertising campaigns. If the request attribute values match one or more advertising campaigns, the visitor request is auctioned and a winning advertising campaign (e.g., highest bid) is selected. The redirect engine determines a redirect resource for the winning campaign from the redirect resource database 130. An indication of the redirect resource is passed to the redirect web server 120 through API 122.

The redirect web server 120 responds to the request from the remote web server by passing a URL for the redirect resource of the winning campaign. In one embodiment, the URL points directly to the resource or action specified by the winning campaign. The owner web server responds to the client device with a response including a URL redirect to the winning campaign resource. In another embodiment, the URL passed to the owner server(s) may point back to the redirect web server 120. The owner web server can then respond to the client device with a URL redirect to the redirect web server 120. Upon receiving the request from the visitor, the redirect web server 120 provides the client device 150 a redirect URL pointing to the resource specified by the winning campaign. The later embodiment may be useful in tracking actual redirects for billing purposes. For example, the URL sent to hosting servers 182 may include a unique identifier for the winning campaign. Upon receiving the client request, the winning campaign owner may be billed or otherwise associated with the redirect.

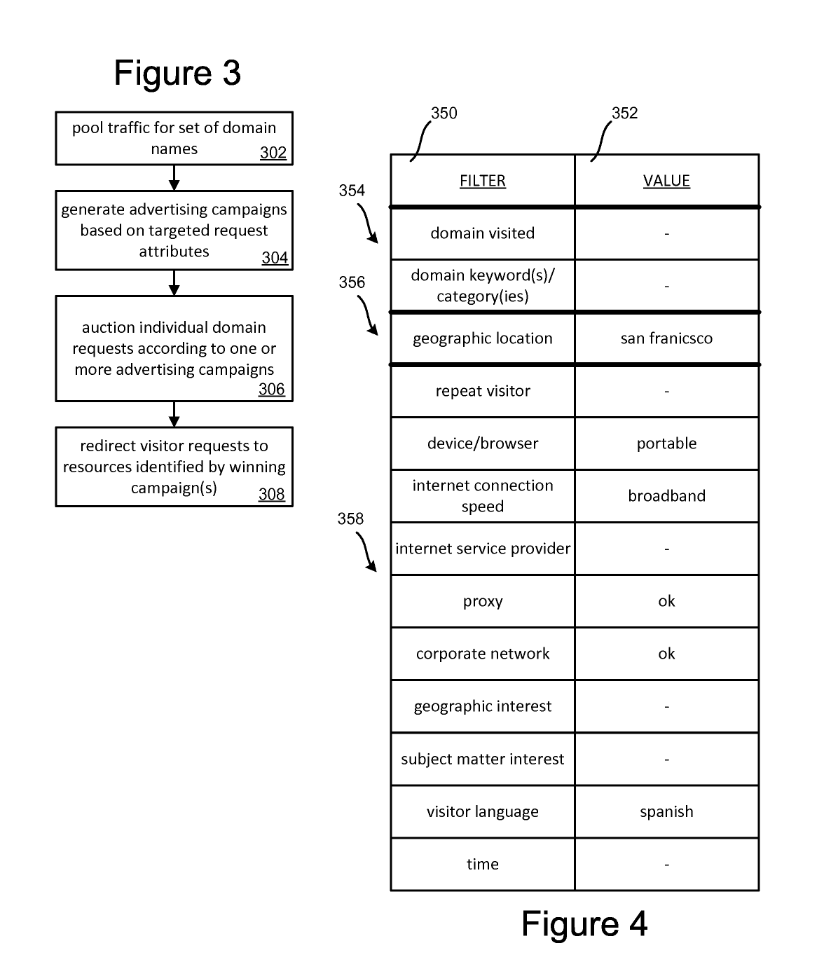

FIG. 3 is a flowchart describing a method of targeted redirect advertising in the domain name channel according to one embodiment of the presently disclosed technology. The traffic for a set of domain names is pooled or aggregated at step 302. A set of domain names is created in one embodiment by maintaining a database of registered domain names and their owners, along with other optional information such as a minimum bid for a redirected user, revenues generated from other monetization streams, etc. Traffic for the set of domain names is aggregated by passing resource requests associated with domains in the set of domain names and/or information derived from the requests in the set to a central redirect engine to determine a resource to which to direct the request based on the request's attributes. The traffic can be centralized and directed to a resource independently of the domain of the resource the visitor actually requests.

Step 302 may also include dynamically adjusting the set of domain names as domain name owners provide requests for bids on internet traffic to the redirect and tracking platform. For example, when a request for a domain name not registered at the platform is forwarded to the platform by a registered domain owner, the platform can automatically add the domain name to the set. Requests for bids on traffic to new domain names may or may not be added to the database of registered domain names. For example, one embodiment includes maintaining the domain names of domains hosted by the redirect and tracking platform, while other embodiments include maintaining the domain names hosted by the platform as well as the domain names forwarded in requests from remote web servers.

At step 304, advertising campaigns are generated based on targeted request attributes. In one embodiment, step 304 includes receiving targeted request attributes from potential purchasers of internet traffic and creating a set of campaign filter values.

At step 306, individual requests associated with the set of domain names are auctioned according to one or more advertising campaigns. Step 306 may include parsing the domain request to determine a number of request attribute values and comparing the attribute values to the set of filter values for each of the pending campaigns. One or more winning campaigns are selected and the corresponding redirect resource for the campaign(s) is then determined.

At step 308, visitors are redirected to one or more resources specified by the winning campaign for their request. Step 308 may include redirecting the visitor to a domain specified by a URL for the redirect resource in one example. In another example, a winning campaign may specify an action such as launching an application of the visitor's client device and optionally directing the application to a resource provided by the purchaser of the traffic.

FIG. 4 is a block diagram depicting an example of a set of campaign filters in accordance with one embodiment. A set of filters 350 correspond to a set of request attribute types that purchasers of internet traffic may wish to target. In FIG. 4, the request attributes are partitioned into domain attributes 354, geographic attributes 356 and visitor attributes 358. Domain attributes correspond to the requested domain of the request. In this example, the domain attributes include the domain visited and domain keyword/category filters. The geographic attributes correspond to the geographic location of the request. It is noted that geographic attributes pertain to the originating location of the request, as distinguished from a geographic interest of the visitor that the system may otherwise determine. The visitor attributes correspond to information about the particular visitor issuing the request. In this example, the visitor attributes include: repeat visitor; device/browser; internet connection speed; proxy; corporate network; geographic interest; subject matter interest; visitor language; and time. The filters in FIG. 4 are exemplary and may vary by implementation including for example, additional filters or less than all of the described filters.

A set of campaign filter values 352 are provided for all or a subset of the available filters. The filter values may be received from potential purchasers of internet traffic directly or derived from information provided by the purchasers and/or information from other available sources. The purchaser can provide values corresponding to targeted visitor attributes of the traffic they wish to receive to create inclusion campaign filters. The purchaser can also provide values corresponding to targeted visitor attributes of the traffic they do not wish to receive to create exclusion campaign filters. It is noted that the filters in FIG. 4 are described by default as inclusion filters specifying visitor attributes that are to be included for the campaign filter to match.

In this particular example, the advertiser has not designated a value for the domain visited filter or the domain keyword/category filter. This indicates that the advertiser wishes to target visitors requesting any available domain in the system. An advertiser may choose to set a domain visited filter to limit users to those requesting a particular domain name. A domain keyword/category filter is further provided, allowing advertisers to target users requesting domains that match one or more supplied keywords or categories. The platform may provide one or more keywords for the domains pooled for traffic auction. The keywords may be manually entered for each domain and stored in the database or determined automatically using textual parsing and analysis, for example. Domain names can further be categorized and categories presented to advertisers from which they may select. In this manner, advertisers can tailor redirections originating to sites in a category they seek to target. The domain name owners may also provide keywords and/or categories for domain names submitted to the redirect and tracking platform.

The advertiser in the example of FIG. 4 has designated a geographic location filter value “san francisco.” The geographic location filter value indicates that the advertiser seeks to target visitors from a particular geographic location, in this case the city of San Francisco. Geographic location filtering permits advertisers to directly target users in exact locations to better allocate their advertising budget. In this manner, local advertisers can allocate their budgets only toward users geographically close to the advertiser so as to avoid costs of reaching users unlikely to generate revenue. Other advertisers may also use this filtering to target promotions to users in a particular area.

A repeat visitor filter is provided. Advertisers may indicate that they wish to limit traffic redirects to those originating from visitors that have already selected the same domain. In this manner, advertisers can target their advertising to visitors expressing a reliable interest in a particular domain for example. In this particular example, the advertiser has indicated no preference for first time or repeat visitors to the redirect and tracking platform.

The advertiser has provided a value of “portable” for the device filter. The device filter refers to the type of client device 150 from which the visitor domain request was received. The device type value in FIG. 4 indicates that the advertiser seeks to target users of portable devices. In one example, specifying a particular device may allow an advertiser to a target subset of consumers to which their product is intended. For example, an advertiser for a software application for a particular type of device may set the device type to the particular type of device for their software. While this example broadly includes a “portable” designation, other values may be more specific, indicating one or more particular brands or model numbers, for example.

The internet connection speed filter is set to broadband, indicating that the advertiser seeks to target visitors with broadband speeds or higher in their connection to the Internet. Advertisers providing bandwidth intensive resources such as websites with Flash technology or applications may wish to target users with connections suitable for viewing or receiving the resources.

The internet service provider filter allows advertisers to filter visitor redirects to traffic from particular internet service providers using an inclusion filter or to traffic not from a particular internet service provider using an exclusion filter. In this example, the advertiser has indicated no preference of internet service provider.

The proxy filter is set to “ok” indicating that the advertiser has no preference for whether the user is using a proxy. Some advertisers may wish to filter traffic originating from proxies due to the likelihood that the visitor attributes may be less accurate.

The corporate network filter indicates that the advertiser has no preference for whether the visitor has a corporate connection to the internet or a non-corporate or personal connection. Some advertisers may wish not to target corporate users, such as advertisers offering entertainment services. In such a case, the advertiser may provide “no” as the filter value. Other advertisers may wish to specifically target corporate users, and may provide “yes” or another indication of such targeting.

A geographic interest filter value can be selected to target visitors exhibiting a defined interest in a particular geographic region. The geographic interest may be determined by parsing and analyzing the domain name to see if a geographic interest is indicated. For example, the domain name may contain a geographical region in its name. Cookies provided with the user request may further indicate a geographic interest, such as by indicating a history of sites visited. The geographic interest filter, a visitor attribute, is distinguished from the geographic location filter, a geographic attribute. The geographic interest filter designates a definable interest expressed by the visitor in a geographical area, while the geographic location filter designates an origin of the visitor's request.

A subject matter interest filter can be selected to target visitors exhibiting a defined interest in a particular subject matter. The subject matter interest may be determined from the request itself in one embodiment, for example from the domain name requested or the domain name from which the visitor came, which can be determined from HTTP header information. A subject matter interest can also be obtained from third-party data sources, such as those using cookies and the like to track internet behavior. The subject matter interest can also be obtained by tracking the visitor's behavior over domains represented by the redirect and tracking platform, directly or using cookie sharing between domains, for example.

The visitor language filter is designated “spanish,” indicating that the user wishes to target visitors able to speak Spanish. An operator of a Spanish language news or entertainment site for example, may wish to provide a Spanish language filter to directly target users indicating Spanish as the default language in their HTTP request.

The time filter allows advertisers to filter visitor redirects to particular time periods using an inclusion filter specifying a particular time period(s) in which to redirect traffic or an exclusion filter specifying a time period(s) in which not to redirect traffic. In this manner, the advertising campaign may only be compared to the attribute values of requests during the specified time period(s).

While shown as a text string in this example, the filter values for the various campaign values may be represented in any suitable manner, including but not limited to strings, sets, regular expressions, ranges and the like. When comparing a set of campaign filter values to a set of request attribute values, the platform may ignore any filters for which the advertiser does not provide a value. Other treatments of unspecified filter values may also be used.

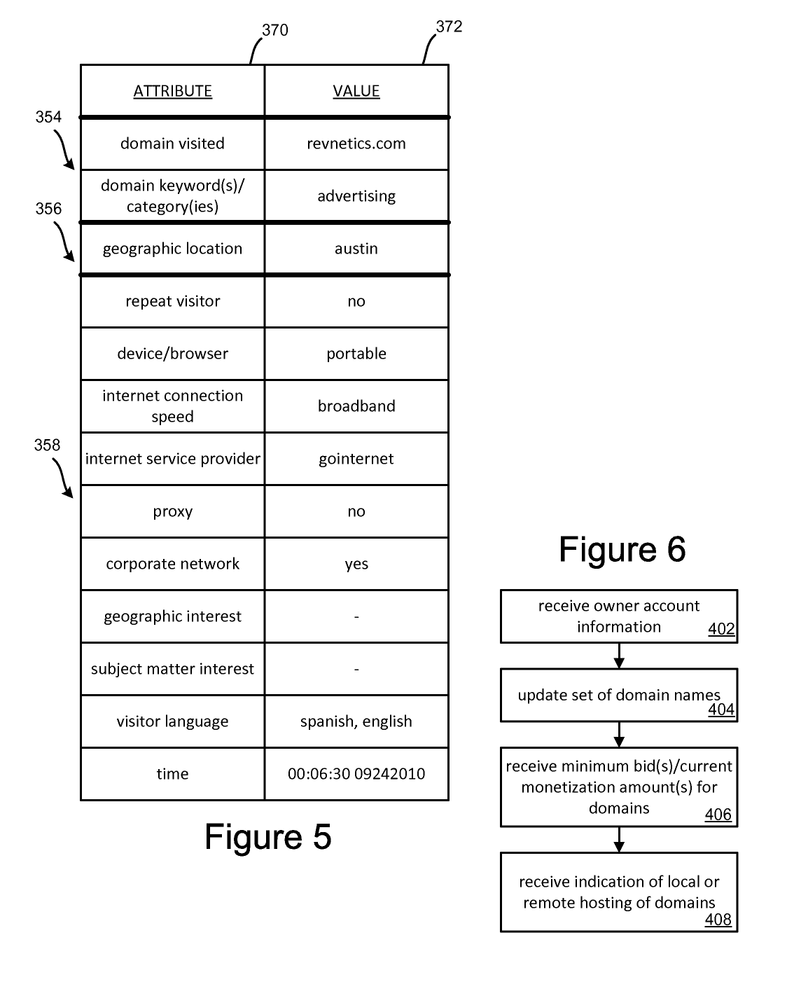

FIG. 5 is a block diagram illustrating a set of request attribute values as can be determined from a visitor resource request associated with a pooled domain name. The request attributes 370, corresponding to the campaign filters 350, are set forth with values 372 for a subset of the potential attributes. In this example, the domain visited value is “revnetics.com,” the domain keyword/category is “advertising,” the geographic location is “austin,” the repeat visitor is “no,” the device/browser value is “portable,” the internet connection speed is “broadband,” the internet service provider is “gointernet,” the proxy value is “no,” the corporate network value is “yes,” the geographic interest is unavailable, the subject matter interest is unavailable, the visitor language values are “spanish” and “english,” and the time value is “00:06:30 09242010.”

The set of request attribute values can be determined from a variety of sources. Some of the visitor attribute values may correspond directly to information in the domain request. For example, the device,/browser, internet connection speed, and visitor language settings may be part of an HTTP header provided with a domain request. The domain visited may be determined directly from the request. Attribute values such as “domain keyword(s)/category(ies),” “repeat visitor,” “internet connection speed,” “internet service provider,” “proxy,” and “corporate network,” may be determined from data sources maintained by the redirect and tracking platform or from third party data sources. For example, the redirect and tracking platform may maintain databases of visitor information from which visitor attribute values are determined. In one example, an internet protocol (IP) address is used as a unique identifier for a visitor. Information about the user can be stored by the platform. When requests are received from the visitor's IP address, visitor attribute values can be determined based on the IP address. The platform may further maintain or access information such as geographic locations, internet connection speeds, internet service providers, proxies, corporate networks, etc. associated with particular IP addresses. The platform may compare the IP address of the request with this information to determine request attribute values.

Data held by the redirect and tracking platform may also be determined by tracking visitors across one or more domains pooled by the platform. For example, cookies can be set on visitor browsers identifying the visitor. The visitor's surfing history across domains in the redirect and tracking platform may be tracked to determine information such as sites the user visits, purchases the user makes, etc.

Third-party data sources may also be used to determine attribute values. For example, cookie exchanges permit the redirect and tracking platform to acquire information that third-parties have acquired using cookies. In one particular example, a third-party data source may indicate, based on an IP address or other identifier, that a visitor has a social networking profile. This information can be used by the advertiser to filter out traffic that is potentially not associated with a human user. For example, a visitor request associated with an IP address of a user having a social networking profile is a good indication that the visitor request is not from an automated bot crawling domains.

When comparing a set of request attribute values to a set of campaign filter values, the platform may ignore any campaign filters for which a visitor attribute value was not determined. These filters will not be applied as a match count in one example. In other examples, a not determined visitor attribute value may be treated as a match with a campaign filter. Campaigns may be set up to require strict matching of each filter value, for example, or may allow unavailable filter values to be ignored.

FIG. 6 is a flowchart describing a method for creating a pool of traffic associated with a set of domain names, as can be performed at step 302 of FIG. 3 by the redirect and tracking platform in one embodiment. In one embodiment, the redirect and tracking platform presents a web interface allowing users that want to auction or sell internet traffic to list domain names and provide account or auction information for selling their internet traffic. In another embodiment, a stand-alone application is provided to enable listing of internet traffic for auction.

At step 402, the platform receives account information from a domain name owner or their representative. Step 402 may include creating an account for a new or first time owner seeking bids from the platform or accessing the account information for an already registered owner. At step 404, the platform updates the list of domain names whose traffic is eligible for auction with domain names indicated by the domain name owner. The domain name owner may explicitly list one or more domain names whose network traffic the owner wishes to sell, thus adding the domain names to the pool. The owners may add or remove domain names from the pool at anytime. In one embodiment, the platform dynamically updates the pool of domain names in real-time as domain names are added and removed from the system. The platform may also add domain names to the pool in response to a domain name owner forwarding a domain name request to the platform for an unlisted domain name. The platform can automatically add the domain name to the pool and auction the forwarded traffic. The new domain name may be added solely for the particular visitor request or can be added for a particular time thereafter or indefinitely.

At step 406, the platform optionally receives one or more minimum bid amounts for redirecting traffic associated with the listed domain name, and/or any current monetization amounts the domain name owner receives for traffic to a listed domain name. A minimum bid amount may be specified so that redirect and tracking platform 110 only redirects traffic associated with a particular domain name if the winning campaign meets or exceeds the minimum bid amount. A domain name owner may also list a current monetization amount it receives by leasing the domain name directly to a lessee under a blanket lease of all traffic. The domain name owner may list the average revenue per visitor it receives under its domain name lease monetization. The domain name owner may alternately or additionally list an average monetization amount per visitor it receives by providing a parked web page with sponsored advertising links. If a current monetization amount is listed for a particular domain, the platform can check the bids for individual requests associated with the domain name, and only provide a redirect for the visitor request if the bid exceeds the other monetization amounts. Step 406 is optional and the domain name owner may choose not to list any minimum bid or current monetization amounts, even if such amounts exist. In such a case, the platform can return a redirect resource in response to visitor requests and a bid amount for the visitor traffic. The domain name owner may check the bid against its current monetization amounts and choose whether or not to provide the redirect resource from the platform. The redirect may point to the platform web servers in such a case to track whether or not the domain owner provided the redirect resource or not.

At step 408, the platform receives an indication of whether the domain is to be hosted by the platform or whether it will be hosted remotely. If hosted locally, the domain owner can update its DNS records to point to the IP address(es) of the web servers of the platform. If a domain is hosted remotely, the platform will return redirect actions to the domain owner web servers. The domain owners can first redirect the visitor to the platform for tracking When the resulting visitor request is received at the platform, a redirect resource to the winning campaign resource is provided. The platform can update billing records when the visitor request is received to note that an actual visitor redirect occurred to the purchaser of the traffic. If a domain is hosted locally, the platform may simply provide a locator for the redirect resource, rather than a first redirect to the platform and a subsequent redirect to the purchaser.

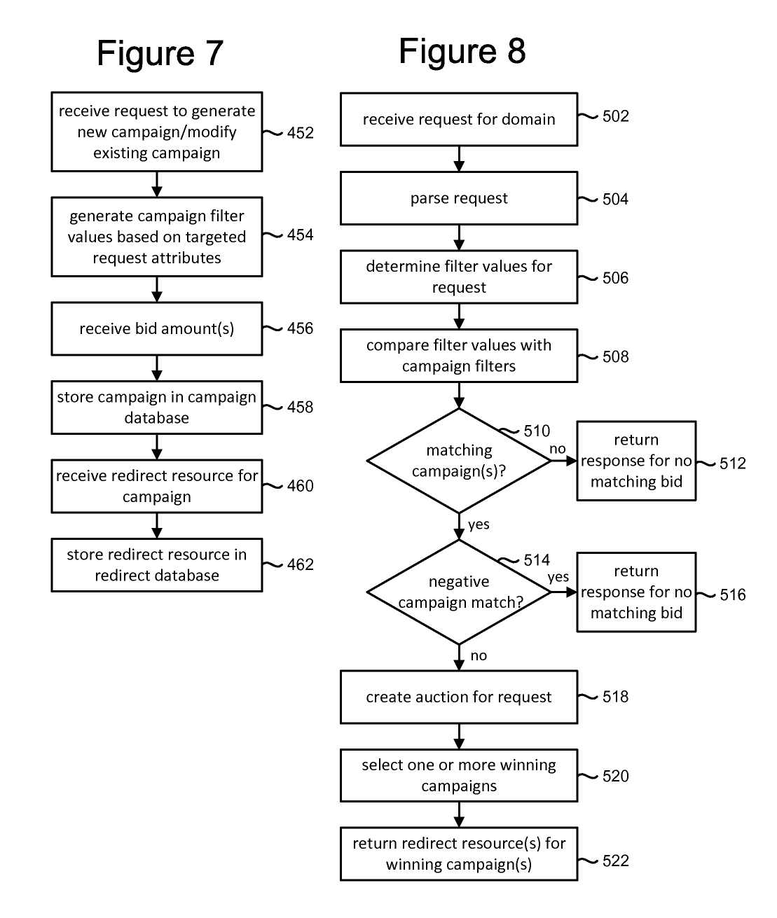

FIG. 7 is a flowchart describing a method of creating advertising campaigns in accordance with one embodiment. In one example, the redirect and tracking platform presents a web interface allowing users wishing to purchase or bid on network traffic to create advertising campaigns. In another, a stand-alone application is provided to enable the creation of advertising campaigns.

At step 452, the platform receives a request to create a new advertising campaign or to modify an existing campaign. Step 452 can include receiving account information from a registered advertiser or if the request is from a new advertiser, creating a new account. At step 454, the platform receives one or more campaign filter values corresponding to targeted visitor attributes for the campaign. Step 454 may include receiving the targeted visitor attributes from the advertiser and generating the filter values in response, or receiving the filter values from the advertiser directly. The campaign filters may be inclusion filters or exclusion filters. An inclusion filter can specify visitor attributes that a visitor request should include to be considered matching while an exclusion filter can specify visitor attributes that a visitor request should not include to be considered matching.

At step 456, the platform receives one or more bid amounts for the campaign. In one embodiment, the advertiser provides a price for each visitor redirect that the platform causes for visitor requests matching the specified set of campaign filter values. A campaign can include more than one bid, with the different bids based on different degrees of matching between a visitor's attribute values and a set of campaign filter values. Consider a campaign having a set of ten campaign filter values. The campaign may specify a first bid amount for visitor requests matching each filter value, and a lower bid amount for visitor requests matching less than all of the filter values (e.g., eight). Any number of bid amounts per campaign can be provided in this manner. Step 456 can include receiving a value from the advertiser specifying a minimum number of matching filters and a corresponding bid amount for visitors including that number of matching filters. Step 456 may further include specifying a bid for a visitor request having a threshold number of matching filter values, and authorizing the platform to discount the bid for visitors with fewer matching filter values.

The advertiser may further specify a maximum amount of funds for a campaign. The maximum amount can be in aggregate, or for a set period of time such as a day, week or month, etc. The platform will enter bids for the campaign until the maximum amount of specified funds is reached. The platform will not enter further bids for the campaign until the specified time renews, such as for a following billing week, month, etc.

Step 456 can further include selecting a calculated value bid option in one embodiment. The advertiser's bid can be automatically calculated by the redirect and tracking platform based on a revenue sharing agreement between the operator of the redirect and tracking platform and the advertiser. Sales or other revenue that the advertiser has received as a result of previous visitors being redirected to their redirect resource can be used to calculate the bid. For example, an advertiser may provide sales or other revenue information that has resulted for visitors that are redirected to their resource, such as a web page. This information can be provided statically or dynamically for updates in real-time and stored by the redirect and tracking platform. When a request that matches the advertising campaign is received, the prior sales data can be used to calculate a bid for the particular request. For example, the bid amount in one embodiment is a value equal to 1/Nth of the total revenue generated from the last N visitors redirected to the advertiser's resource. The value can be adjusted (either positively or negatively) based on a configurable profit margin for the revenue. In one example, instead of using a value equal to 1/Nth of the total revenue, the value can be equal to 1/Nth of the total revenue the advertiser receives less an amount the platform receives from the total revenue under an agreement with the advertiser.

At step 458, the new or modified campaign, including its set of filter values, is stored in the campaign database. At step 460, the platform receives an identifier of a redirect resource from the user for the campaign. The redirect resource may be identified by any designation or locator of a network service to which a visitor may be redirected. For example, the redirect resource may be specified by a URL of a domain to which the visitor will be forwarded or redirected if the campaign wins the auction associated with the visitor request. The redirect resource may include actions in addition to or in place of providing an alternate domain to the visitor. For example, a redirect resource may specify launching an application at the visitor's client device 150 in response to a matching request. An application may be launched by providing a URL in one example. The URL may specify a protocol to cause the client device to invoke a particular application, such as by using the “call:” protocol to invoke a phone application, a “mailto:” protocol to invoke an email application or an “SMS:” protocol to invoke a short messaging service application. At step 462, the redirect resource identifier is stored in the redirect resource database and associated with the campaign.

FIG. 8 is a flowchart describing a method of auctioning individual domain requests as may be performed at step 306 of FIG. 3. At step 502, a request associated with a domain in the set of domain names is received. A visitor request may be received directly at the platform, such as when the platform is hosting the requested domain. In other cases, the domain owner may host or have hosted their domain remote from the platform, and use URL forwarding to redirect the visitor to the platform where their request will be received. In yet another example, the domain name owner receives the visitor request, and in response accesses the platform API to pass the request to the redirect engine. The visitor need not be redirected to the platform. The domain name owner may pass the full HTTP request or it may parse the request and pass portions of the request to the platform for analysis. Requests at step 502 may include any suitable protocol including, but not limited, to HTTP, FTP, etc.

At step 504, the visitor request is parsed at the platform if not already parsed by the domain name owner. Parsing the request can include accessing HTTP headers, cookies and a URL of the request to obtain request attribute information. The request attribute information may be obtained directly from HTTP requests and the like, and also from other data sources using the requests.

At step 506, the redirect engine determines a set of filter values for the visitor request. The redirect engine may pass portions of the visitor attribute information to the various filters and receive a filter value in return. In some cases, a filter value may not be able to be determined. In such a case, the visitor attribute value for a particular filter may be left blank or undetermined. Different options for handling undetermined filter values can be used. In one embodiment, the visitor attribute values are the same as the visitor attribute information. At step 508, the visitor attribute values are compared with the set of filter values in each of the pending campaigns. Various matching algorithms can be used. Any matching campaigns are identified at step 510. Determining whether a campaign matches can include determining whether the campaign specified a bid amount at or above the minimum specified by the owner to which the visitor traffic was originally directed. In other examples, the minimum bid amounts can be considered after determining a winning campaign(s) at step 520.

If no campaigns match the visitor request, the redirect engine returns a response that there is no match at step 512. If there is at least one matching campaign, the redirect engine determines whether any of the matching campaigns are a negative campaign at step 514. Negative campaigns can be included by the platform to filter particular traffic from the system. If the visitor attribute values match the negative campaign filters, a response that there is no match can be returned by the redirect engine at step 516. For example, a negative campaign may specify a dial-up internet connection value for a connection speed filter. If the visitor request is determined to be from a dial-up connection, thus matching the connection speed filter, a response indicating no matching campaign can be returned at step 516. Other examples may include specifying a geographic region in a negative campaign to filter all traffic from the geographic region so that it is not subject to bidding.

If there are no negative campaigns in the set of matching campaigns, an auction for the visitor request is created at step 518. At step 520, a winning campaign from the matching campaign is selected. Step 520 can include various selection algorithms. In a most basic example, step 520 includes selecting the matching campaign with the highest bid for the visitor traffic. For campaigns with more than one bid amount, the system may use the highest bid corresponding to the number of attribute values matching the campaign filters. In another example, an advertiser may authorize the platform to automatically discount their bid if a visitor request does not match all of the campaign filters but matches some. For example, the system may discount the bid by a set amount for each non-matching filter value and put the campaign into the auction with a bid amount determined by the number of matching filter values.

Step 520 may include selecting more than one winning campaign. For example, multiple campaigns may be ranked according to bid value in one example. The visitor may first be redirected to the resource of the campaign with the highest bid. As described hereinafter, the visitor may be redirected to other winning campaigns with lower bids in response to timed redirects and/or selection by the visitor on a next advertisement link on the resource of a campaign to which the visitor was previously directed. In other examples, multiple campaigns may have the highest bid. The platform can use different techniques for redirecting traffic according to the different winning campaigns. In one example, the platform selects the winning campaign that has been on the platform the longest. In another example, the platform may select the campaign for which it has been the longest since a redirect to their resource has taken place.

After determining the winning campaign or campaigns, the redirect resource associated with the winning campaign is returned at 522. Step 522 can include returning the resource to a requesting web server, either local 120 or remote 184, through API 122. Step 522 may also include returning the resource directly to the visitor. The redirect resource can be provided as a response to the visitor's original request from the web server. The redirect resource can be provided to the user using any suitable resource locator, such as by passing a URL for the redirect resource to the visitor using URL redirection.

At steps 512 and 516, a response indicating that there are no matching bids is provided. In various implementations, the redirect web server of the redirect and tracking platform and/or the remote web servers of the domain name owners may provide alternate responses when there are no matching bids for the particular visitor request. In one example, the web servers may respond to the visitor by directing them to a parked page hosting one or more sponsored advertising links. The web servers may provide these parked web pages directly or may direct the visitor to an alternate server hosting this content. The web servers may also redirect the visitor using an alternate redirection technique. For example, the domain owner may receive bids from potential lessees for leasing the domain directly. If there are no matching campaigns for the individual request, the web servers may redirect the visitor request to a redirect resource specified by the winning bid under a lease-based redirect option.

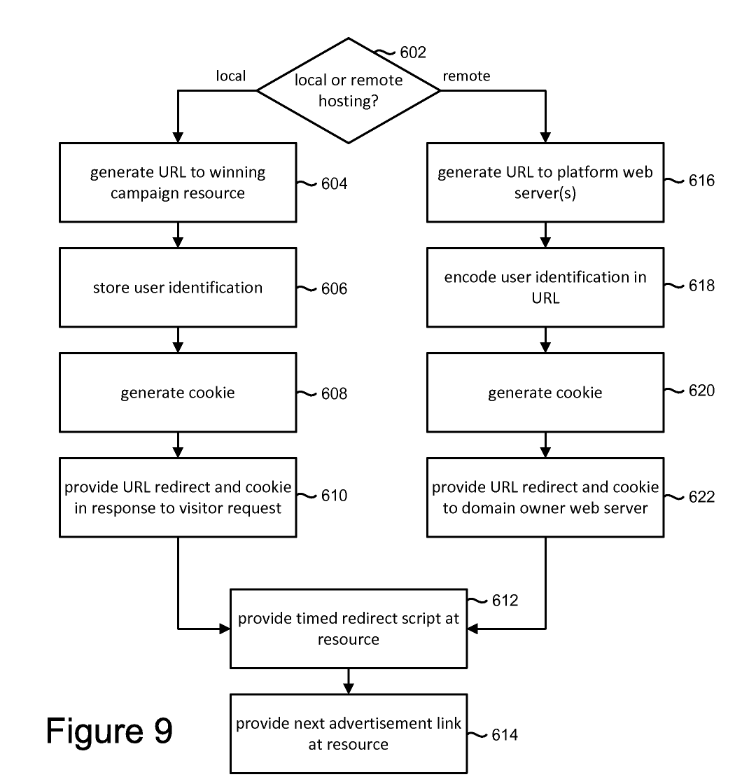

FIG. 9 is a flowchart describing a method of redirecting visitor requests as can be performed at step 308 of FIG. 3 in one embodiment. The redirect engine first determines whether the visitor request is associated with a locally hosted domain or a remotely hosted domain at step 602. If the domain is locally hosted, the redirect engine generates a URL identifying the winning campaign redirect resource at step 604. At step 606, a user identification for the visitor is stored at the redirect and tracking platform. In one example, the platform stores the IP address of the visitor request as a unique identifier, although other identifiers can be used. At step 608, a cookie is optionally generated uniquely identifying the visitor for potential tracking At step 610, the redirect resource and optional cookie are provided in response to the visitor request. Step 610 can include providing an HTTP response to the visitor request and setting the cookie on the client device in one example. It is noted that steps 604-610 may be performed by the redirect engine, which will formulate the data and pass it to the web host. Steps 604-610 may alternately be performed by the web host after receiving the redirect resource from the redirect engine.

If the domain is remotely hosted, the redirect engine generates a redirect URL to the redirect and tracking platform web servers at step 616. At step 618, a unique visitor identification is encoded in the redirect URL and at step 620, a cookie is optionally generated for uniquely identify the visitor. At step 622, the redirect URL including the unique identifier and the cookie are provided to the remote web server. The remote web server can in turn provide an HTTP response to the visitor domain name request including the URL direct. The optional cookie can be set on the visitor's client device. The visitor will first be directed to the redirect and tracking platform web servers. The visitor's request will pass the cookie generated at step 620, if set on the client device. The platform server's can use the cookie and/or the unique identifier encoded in the redirect URL to determine the auction associated with the visitor. The platform server accesses the redirect resource specified by the winning campaign and generates an HTTP response to the user containing a URL to the redirect resource of the winning campaign.

FIG. 9 further depicts steps 612 and 614 as may optionally be performed for requests associated with either locally or remotely hosted domains. At step 612, a timed redirect script is provided at the winning campaign redirect resource. The timed redirect script can cause a redirect of the visitor away from the winning campaign resource if no action is taken at the resource within a specified period of time. In one example, the redirect and tracking platform may provide the script to the advertiser, who can add the script to their resource such as a web page to which the user is directed. The script may load and run from the advertiser's website and redirect the visitor at the expiration of the predetermined period of time. In another example, the advertiser's page may be framed with the primary content in one or more frames and a redirect script loaded from the redirect and tracking platform in a smaller frame to execute the timed redirect. If no interaction occurs in the specified period of time, the visitor is redirected. The redirect script may contain a redirect to the URL of another campaign. Alternatively, the redirect script may contain a redirect to the URL of the platform, which can then provide a redirect to the URL of another campaign.

The timed redirect may ultimately redirect the visitor to the resource of another campaign at the platform or to another resource, such as a resource (e.g., a parked page) of the originally requested domain. In either case, the original campaign's bid may be refunded in full or part in response to the visitor taking no action at their resource. In one embodiment, the redirect from the first campaign's resource is back to the redirect and tracking platform. The platform can access a cookie or unique identifier of the visitor, and determine another campaign's resource to which to direct the visitor. In one example, a matching campaign for the visitor's original request that was next highest to the winning campaign is selected and the visitor is directed to their resource. If more than one campaign had the highest bid in the original auction, another winning campaign can be selected for redirection of the visitor.

At step 614, an optional next advertisement link is provided at the winning campaign's resource. The next advertisement link may point to another winning campaign for the original visitor request, or a next highest bidding campaign as with the timed redirect at step 612. In one embodiment, the original advertiser is refunded, in full or in part, in response to the visitor selecting the next advertisement link. The next advertisement link may be a URL directly linking to the next advertiser in one example. In another example, the link may be URL linking to the redirect and tracking platform. When the request generated from selecting the link is received at the redirect and tracking platform, the user's unique identification or cookie can be accessed to identify the associated campaign. The platform can determine the next resource to which to direct the visitor, and in response to the request, provide a URL redirect to the next advertiser's resource.

In one embodiment, a billing database at the redirect and tracking platform is used to track redirects and settle the accounts between advertiser and domain name owner. With respect to FIG. 9, an indication of a redirect can be stored when a URL redirect is provided to the visitor in response to their original domain request at step 610. For remotely hosted domains, the platform can store an indication of a redirect when the request is received from the visitor after being redirected by the remote web server at step 622. The platform may store the indication of a redirect with the advertiser's ID, the domain owner's ID, and bid amount, among other information.

The redirect and tracking platform may settle accounts periodically with advertisers and domain name owners. For example, the platform may settle accounts monthly by the total amount of the advertiser's winning bids for the month. Likewise, the platform may settle a domain name owner's account by determining the total amount of the bids for each redirect effected for the domain name of the owner. Accounts may be settled in any fashion, for example using different periodic time periods or even currently with each redirect effected by the platform.

Accounts can be settled using funds from accounts linked to the redirect and tracking platform in one embodiment. For example, advertisers and domain name owners may provide bank account information and the platform may withdraw and deposit funds periodically in accordance with the bids provided or received by the advertiser and owner, respectively. Other techniques may be used to transfer funds, such as through funded accounts maintained by the platform, credit cards, etc. In one embodiment, the redirect and tracking platform receives a percentage of the bid amounts received by each domain name owner.

In one embodiment, an option to opt-out of any further redirects of visitor requests is provided to the visitor. The option to opt-out can be provided as a link on a redirect resource web page for example, or on a parked web page to which the domain requests are normally directed. The redirect and tracking platform can receive an indication that the link has been selected and update a visitor profile with information indicating that the visitor does not wish to be redirected in response to any future domain requests. When a future request is received, the system can check to see if profile information is stored for the particular visitor. The visitor's IP address or a cookie received from the visitor may be checked. The platform can further respond to third-party indications of a visitor's intention to opt-out of redirects. For example, governmental entities, Internet Service Providers, industry associations and other third-parties may provide a cookie that is set on a client device for the redirect and tracking platform domain. The platform can respond to these cookies by not causing any redirects when they are detected.

In one embodiment, a disqualification system is provided to account for actions by a visitor that indicates a determined visitor filter value was incorrect. For example, consider a visitor that is determined to be from a particular geographical region, e.g., the USA. If that visitor is redirected to an advertiser's resource where it is determined that the visitor is actually from Canada, the filter data in the redirect and tracking platform can be updated to reflect that the visitor is actually in Canada. This may be determined, for example, by the user filling out a form, etc. on a web page (e.g., in making a purchase or in registering) where they indicate they are in Canada. Optionally, the advertiser can be refunded the amount of their bid since the filter data that resulted in redirecting the visitor was determined to be incorrect.

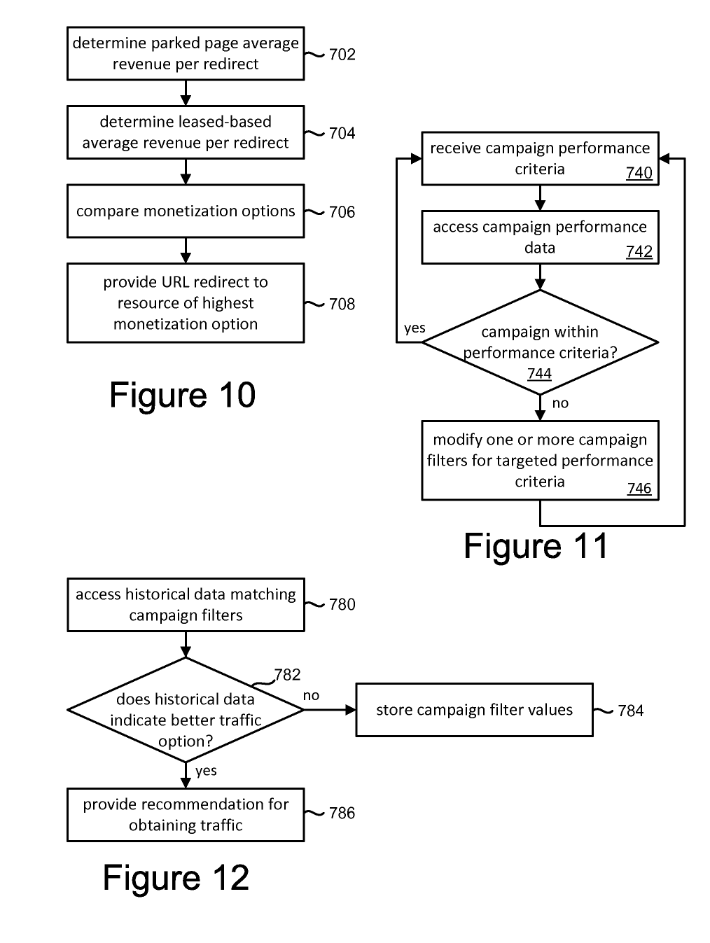

FIG. 10 is flowchart describing additional options for returning a response to the visitor, as can be incorporated into steps 610 or 622 of FIG. 9. The options in FIG. 10 permit locally or remotely hosted domains to receive alternate monetization streams in addition to that provided by the redirect and tracking platform.

At step 702, an average revenue per visitor redirect for displaying a parked page with sponsored advertising links is determined. At step 704, an average revenue per visitor redirect under a leased-domain option is determined. At step 706, the various monetization options for the visitor redirect are compared. At step 708, a redirect resource is provided in response to the visitor request that will generate the highest monetization.

In one embodiment where a domain is hosted remotely, FIG. 10 may be performed by the remote web server. The redirect and tracking platform may provide a redirect URL for the winning campaign and the bid amount for the visitor redirect. In another embodiment where a domain is hosted locally or remotely, FIG. 10 may be performed by the redirect and tracking platform. The redirect and tracking platform may determine the other monetization options from information provided by a domain name owner during registration, for example. The platform can compare the various monetization options. If a domain is hosted remotely and the platform bid is not the highest option, the platform may return a no bid response or otherwise indicate to the remote web server that the visitor-based redirect bid is not the best option.

FIG. 11 is a flowchart describing a method of generating campaign filters in one embodiment that incorporates an automated filter selection process. At step 740, the platform receives campaign performance criteria from the advertiser. The advertiser may specify a desired amount of traffic in a set period of time (e.g., number of visitor redirects per day), a budget or amount to spend on redirects in a set period of time, a targeted amount of revenue it wishes to generate from each redirect, etc.

At step 742, the platform accesses actual campaign performance data, such as the redirects per day, cost per day, or revenue generated from redirects. The advertiser may provide a feedback loop to the platform of the revenue that is being generated per redirect or may provide an average figure. At step 744, the platform compares the campaign performance data with the campaign performance criteria. If the campaign is within the criteria, the process continues by receiving additional campaign performance criteria (if provided) at step 740 or continuing to monitor the campaign performance at step 742.

If the campaign performance data is not within the criteria, one or more campaign filters are modified for the campaign at step 746. Step 746 may include deleting filters, adding filters or modifying existing filters. For example, if a campaign is not receiving a desired amount of traffic or the allocated budget is not being utilized, a filter may be removed or modified and the campaign monitored to see if the amount of traffic or costs for redirects increases. If a campaign is receiving too much traffic, a filter may be added or modified to see if the amount of traffic or costs for redirects decreases. Similar modifications may be made in response to the revenue generated from redirected visitors not meeting performance criteria. Consider an advertiser that has limited their redirects to users of a particular type of device (e.g., an iPhone). The platform may modify the filter to limit redirects to users of a different type of device (e.g., Android) to see if their revenue generated from redirected visitors increases. The platform may modify campaigns automatically without further advertiser input to meet performance criteria.

FIG. 12 is a flowchart describing a method of generating campaign filters in one embodiment that incorporates an automated recommendation of alternate campaigns or monetization options. After an advertiser has submitted a set of campaign filters, the platform accesses historical data at step 780 and determines a percentage of historical visitors to the platform that match the campaign. Step 780 may further include analyzing the individual visitors matching the campaign to assess their attributes for comparison with desired attributes of visitors for the campaign. At step 782, the system determines whether the historical data indicates that the targeted visitor attributes may be better targeted under an alternate campaign or advertising option. For example, the platform may determine that 90% of traffic matching the set of campaign filters is likely to come from a particular domain based on the historical data. At step 786, the platform makes a recommendation to the advertiser based on the historical data comparison at step 782. For example, the platform may recommend that the user purchase the domain from which the 90% of traffic originates in the earlier example. The platform may make other recommendations, such as to directly lease the domain from which the traffic originates if a direct lease of the domain offers a lower cost per redirect than a run-of-network bid for visitors originating from that domain. If the historical data does not indicate that there exists a better option for directing traffic to the advertiser, the campaign filter values are stored for the campaign at step 784.

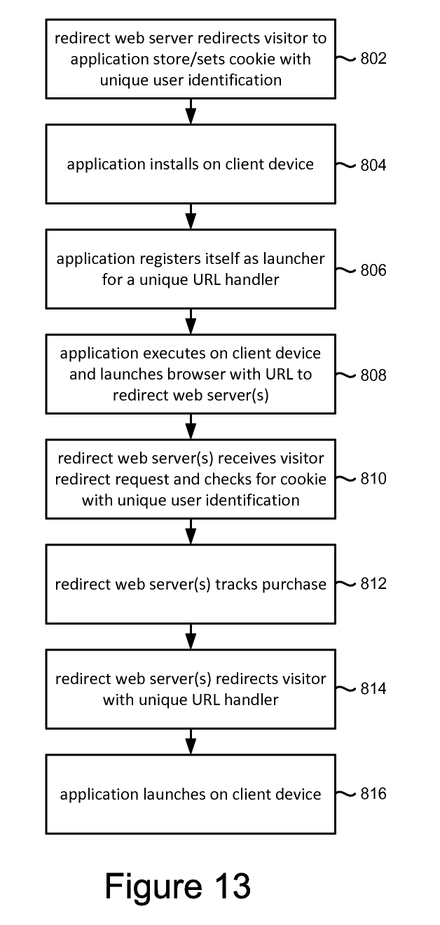

FIG. 13 is a flowchart describing a process according to one embodiment that includes redirecting a visitor to a networked application store while providing conversion tracking for any purchases of a specified application by the visitor at the application store. In one embodiment, the process of FIG. 13 is performed as part of and/or in response to returning a redirect resource as set forth in step 522 of FIG. 8. An advertiser may specify the URL of an application store as a redirect resource for an advertising campaign. These resource URLs may specify a location or service for a particular product within the application store. For example, an application developer may specify the URL of a page in an application store for purchasing a particular software application. If the winning campaign specifies such a URL as the redirect resource, the redirect web server will provide the redirect resource to the visitor, causing the visitor's client device to access the purchasing page for the specified application in the application store. FIG. 13 provides a technique for tracking whether the visitor actually purchases a product associated with a redirect resource provided to a visitor in response to a winning campaign for the visitor's resource request.

After determining that the specified redirect resource for a winning campaign is a URL for an application in an application store, the redirect web server redirects the visitor to the application store at step 802. In one example, step 802 includes redirecting the visitor to a particular page within the application store for purchasing a particular software application. Step 802 also includes setting a cookie on the visitor's client device (e.g., internet browser) that specifies a unique user identification for the visitor. The cookie is set for the domain of the redirect web server in one embodiment.

If the visitor purchases the specified application, the application is installed on the client device at step 804. If the visitor does not purchase the specified application, no further action is taken. As part of or after the application installation, the application registers itself at step 806 as the launcher or executing application for a unique URL handler. At client devices, URL handlers such as HTTP, FTP, telnet and the like are typically associated with specified applications that are invoked to retrieve resources that are specified in a URL with the particular handler. In step 806, the application registers itself with the client device as the application to be called when the unique handler is specified in a URL. Any notation not used for another URL handler can be used for the unique URL handler at step 806.

After the application is installed and the unique URL handler is registered, the application launches or is executed at step 808. The application includes code or a script that issues a request for the redirect web server domain when it is launched. For example, the code may request a URL containing the redirect web server domain, causing a browser or other application on the client device to issue a request to the redirect web server. In another example, the application itself may issue the request. This code may be executed the first time the application is launched, every time the application is launched or at specified intervals.

At step 810, the redirect web server receives the request from the visitor's client device and checks for any cookies associated with the redirect web server domain. If any cookies are present, the redirect web server determines the unique user identification from the cookie. At step 812, the redirect web server tracks the visitor's purchase of the application at the application store. For example, the redirect web server may store the unique user identification when the visitor is initially redirected at step 802. The ID may be stored with an identifier of the winning campaign which caused the visitor redirect. At step 812, the redirect web server may update the database to indicate that the visitor purchased the application associated with the winning campaign's redirect resource. If the redirect web server receives a request from a visitor without a cookie for the domain, it can also track this information. In this manner, the application developer may track how many purchases result from redirects using the redirect web server system and how many purchases do not.

The application may also track information of user's utilizing its application and provide that information to the redirect web server. For example, the application may track for how long a visitor uses the application, where the visitor users the application or any other type of information associated with the application. This information may be provided to the redirect web server with the visitor's unique identification to update the database with this type of tracking information as well.

After tracking the visitor purchase at step 812, the redirect web server again redirects the visitor at step 814. The URL specified in the redirect at step 814 includes the unique URL handler associated with the application on the client device at step 806. Accordingly, the visitor's client device will issue a resource request having the unique URL handler when it receives the redirect URL. In turn, the application on the client device will be called at step 816 to service the request. This causes the application to again launch on the client device. By immediately redirecting the visitor with the unique URL handler, the redirect web server is able to track conversions of visitor's in the application store while providing a seamless transition between resources. At step 808, the application causes the client device to issue a request to the redirect web server, which at step 814 will issue a redirect causing the application to again launch on the client device. In this manner, the application launches automatically so that the visitor's purchase can be tracked without disrupting use of the application.

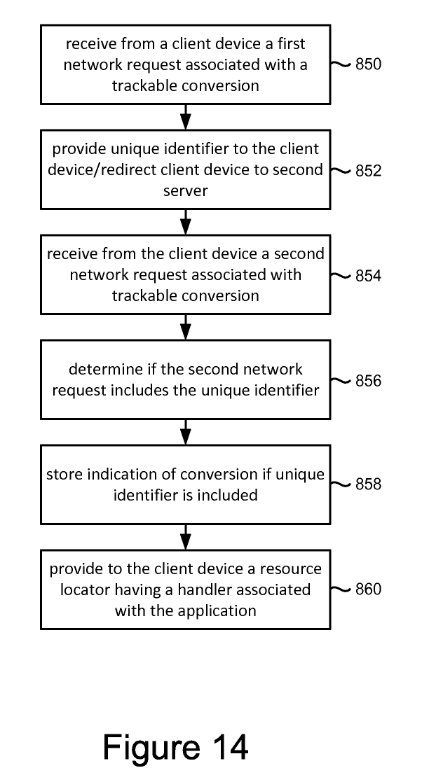

The process of conversion tracking set forth in FIG. 13 may be implemented independently of redirecting network traffic associated with a set of domain names as provided in FIG. 3. FIG. 14 is a flowchart describing a method of tracking whether a visitor request results in a conversion, such as tracking whether a visitor request results in the acquisition of an application by the visitor. At step 850, a request associated with a trackable user conversion is received at a first server. The request may be an HTTP request originating from a visitor selection of a link or from the direct entry of an URL into a browser for example. The first server may be the redirect web server(s) 120 in one example, but need not be. For example, the technique in FIG. 14 may be used by any server to track whether user selections of links or direct URL entries result in a user conversion. A user conversion may include an acquisition by the visitor of an application associated with the network request. For example, the request may be an HTTP request resulting from a visitor's selection of a link that is indicated to direct the visitor to a network resource for purchasing or otherwise acquiring an application or product from an online application store.

At step 852, the first server provides a unique identifier to the client device and redirects the client device to a second server where the application can be acquired by the visitor. For example, the second server may host the application store from which the visitor may download the application after paying a fee. In one example, step 852 includes responding to the request at step 850 with a URL redirect to the second server. The URL redirect may include a cookie which is set on the client device (e.g., on a browser application) and includes the unique identifier. The URL redirect may point directly to a location for acquiring the application.

In response to the URL redirect, the client device provides a request to the second server. The application may then be acquired by the client device at the second server. The client device may then install the application. The application can register itself as the application for a unique URL handler as set forth in step 806 of FIG. 13. When the application executes, a second request is issued by the client device to the first server. The second request includes the unique identifier.

At step 854, the second network request is received at the first server. The second network request is associated with acquisition of the application. The cookie set at step 802 may be accessed to determine if the unique identifier is included with the second network request at step 856. If the unique identifier is included in the second network request, the first server can store at step 858 an indication that the visitor associated with the unique identifier did acquire the application. This information can be associated with a particular campaign in one example. In this manner, the first server is able to track whether the visitor's first network request was converted into an acquisition of the application. The first server is then able to track whether acquisitions such as purchases occur at a remote server.

At step 860, the first server provides another URL redirect to the client device. The URL redirect can include the handler for which the application registered itself at the client device. Upon receiving the URL redirect, the client device will launch the application. Thus, the visitor's installation and execution of the application will not appear disrupted. The application, upon execution, can direct the client device to the first server, where it will be directed back to the application automatically.

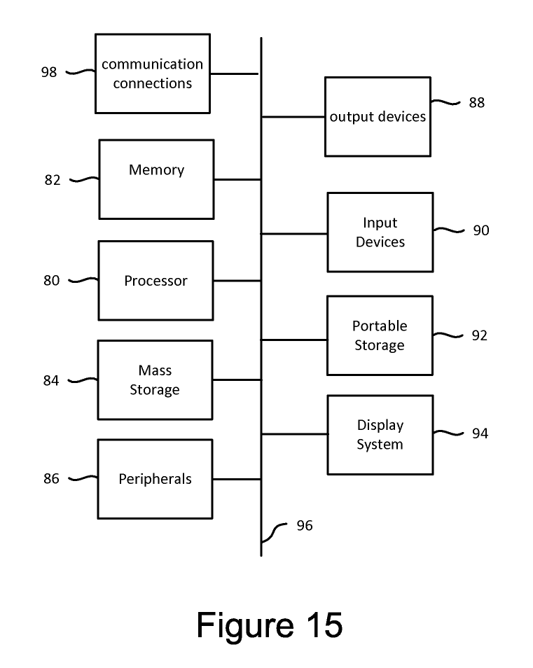

FIG. 15 is a high level block diagram of a computing system which can be used to implement any of the computing devices of FIGS. 1 and 2. The computing system of FIG. 15 includes processor 80, memory 82, mass storage device 84, peripherals 86, output devices 88, input devices 90, portable storage 92, and display system 94. For purposes of simplicity, the components shown in FIG. 15 are depicted as being connected via a single bus 96. However, the components may be connected through one or more data transport means. In one alternative, processor 80 and memory 82 may be connected via a local microprocessor bus, and the mass storage device 84, peripheral device 86, portable storage 92 and display system 94 may be connected via one or more input/output buses.

Processor 80 may contain a single microprocessor, or may contain a plurality of microprocessors for configuring the computer system as a multiprocessor system. Memory 82 stores instructions and data for programming processor 80 to implement the technology described herein. In one embodiment, memory 82 may include banks of dynamic random access memory, high speed cache memory, flash memory, other nonvolatile memory, and/or other storage elements. Mass storage device 84, which may be implemented with a magnetic disc drive or optical disc drive, is a nonvolatile storage device for storing data and code. In one embodiment, mass storage device 84 stores the system software that programs processor 80 to implement the technology described herein. Portable storage device 92 operates in conjunction with a portable nonvolatile storage medium, such as a floppy disc, CD-RW, flash memory card/drive, etc., to input and output data and code to and from the computing system. In one embodiment, system software for implementing embodiments is stored on such a portable medium, and is input to the computer system via portable storage medium drive 92.

Peripheral devices 86 may include any type of computer support device, such as an input/output interface, to add additional functionality to the computer system. For example, peripheral devices 86 may include one or more network interfaces for connecting the computer system to one or more networks, a modem, a router, a wireless communication device, etc. Input devices 90 provide a portion of a user interface, and may include a keyboard or pointing device (e.g. mouse, track ball, etc.). In order to display textual and graphical information, the computing system of FIG. 15 will (optionally) have an output display system 94, which may include a video card and monitor. Output devices 88 can include speakers, printers, network interfaces, etc. Device 100 may also contain communications connection(s) 112 that allow the device to communicate with other devices via a wired or wireless network. Examples of communications connections include network cards for LAN connections, wireless networking cards, modems, etc. The communication connection(s) can include hardware and/or software that enables communication using such protocols as DNS, TCP/IP, UDP/IP, and HTTP/HTTPS, among others.

The components depicted in the computing system of FIG. 15 are those typically found in computing systems suitable for use with the technology described herein, and are intended to represent a broad category of such computer components that are well known in the art. Many different bus configurations, network platforms, operating systems can be used. The technology described herein is not limited to any particular computing system.

The technology described herein can be implemented using hardware, software, or a combination of both hardware and software. The software may be stored on one or more processor readable storage devices as described above (e.g., memory 82, mass storage 84 or portable storage 92) having processor readable code embodied thereon for programming one or more processors to perform the processes described herein. The processor readable storage devices can include non-transitory, tangible computer readable media such as volatile and non-volatile media, removable and non-removable media. Tangible computer readable media may be implemented in any method or technology for storage of information such as computer readable instructions, data structures, program modules or other data. Examples of tangible computer readable media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other non-transitory, tangible medium which can be used to store the desired information and which can be accessed by a computer. In alternative embodiments, some or all of the software can be replaced by dedicated hardware including custom integrated circuits, gate arrays, FPGAs, PLDs, and special purpose computers. In one embodiment, software (stored on a storage device) implementing one or more embodiments is used to program one or more processors. The one or more processors can be in communication with one or more tangible computer readable media/ storage devices, peripherals and/or communication interfaces.

The foregoing detailed description has been presented for purposes of illustration and description. It is not intended to be exhaustive or to limit the invention to the precise form disclosed. Many modifications and variations are possible in light of the above teachings. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A computer-implemented method of directing network traffic, comprising:
determining a set of request attribute values for each request in network traffic associated with a plurality of domain names;
comparing each set of request attribute values to a plurality of campaigns, each campaign including a plurality of campaign filter values;
selecting one or more campaigns for each request in the network traffic based on comparing the set of request attribute values for each request to the plurality of campaigns; and
redirecting each request in the network traffic according to at least one redirect resource specified by the one or more selected campaigns.

2. A computer-implemented method according to claim 1, wherein:
selecting one or more campaigns for each request in the network traffic includes selecting a first campaign for a first request in the network traffic that is received from a client device;
the first campaign specifies a first redirect resource including a redirect action for executing a first application at the client device; and
redirecting the first request includes providing a resource locator to the client device, the resource locator including a handler associated with the first application.

3. A computer-implemented method according to claim 1, further comprising for a first request in the network traffic:
determining that two or more campaigns match the set of request attribute values in response to comparing the set of request attribute values for the first request;
creating an auction for the first request; and
comparing at least one bid amount for the first request from each of the two or more campaigns;
wherein selecting one or more campaigns for the first request includes selecting at least one of the two or more campaigns based at least in part on the bid amounts from each of the two or more campaigns.

4. A computer-implemented method according to claim 1, wherein:
selecting one or more campaigns for the first request includes selecting a first campaign and selecting a second campaign;
the first campaign specifies a first redirect resource;
the second campaign specifies a second redirect resource;
the first redirect resource includes a timed redirect script resulting in redirection of the client device to the second redirect resource after a specified period of time.

5. A computer-implemented method according to claim 4, wherein:
the timed redirect script includes a locator redirect to the first server;
the first server provides to the client device a locator redirect to the second redirect resource.

6. A computer-implemented method according to claim 1, further comprising:
receiving the network traffic including the requests associated with the plurality of domain names.

7. A computer-implemented method according to claim 1, further comprising generating each of the plurality of campaigns, wherein generating each of the plurality of campaigns includes:
receiving from a user a set of targeted request attributes;
generating one or more campaign filter values for each targeted request attribute;
receiving from the user one or more bid amounts for redirecting network traffic according to the each campaign;
receiving from the user an identifier of a redirect resource for redirecting network traffic according to the each campaign; and
storing the campaign in one or more computer-readable media.

8. A computer-implemented method according to claim 1, wherein determining the set of request attribute values for each request in the network traffic includes:
parsing a header of the request to determine one or more domain attributes, one or more geographic attributes and one or more visitor attributes; and
determining one or more domain attribute values based on the one or more domain attributes, one or more geographic attribute values based on the geographic attributes and one or more visitor attribute values based on the one or more visitor attributes.

9. A computer-implemented method according to claim 7, wherein determining the set of request attribute values for each request in the network traffic further includes:
determining at least one request attribute value from a third-party data source based on an identifier associated with the each request.

10. A computer-implemented method according to claim 1, wherein
the at least one redirect resource is specified by a uniform resource locator; and
redirecting each request in the network traffic includes providing the uniform resource locator in response to the request.

11. A computer-implemented method of controlling network traffic, comprising:
receiving from a client device a network request associated with a first domain name in a set of aggregated domain names;
determining from a plurality of redirect resources a first redirect resource based on a set of request attribute values for the network request, the first redirect resource being associated with a second domain name; and
returning a resource locator for the first redirect resource associated with the second domain name to the client device in response to the network request associated with the first domain name.

12. A computer-implemented method according to claim 11, wherein:
the network request is received from a first application on the client device; and
the resource locator for the first redirect resource includes a resource locator handler associated with execution of a second application on the client device.

13. A computer-implemented method according to claim 12, wherein:
the second application is associated with an application store, the resource locator for the redirect resource redirects the client device to a purchase page for a third application at the application store.

14. A computer-implemented method according to claim 11, further comprising:
pooling network traffic associated with the set of aggregated domain names at a set of one or more web servers;
receiving the network request at the set of one or more web servers;
parsing the network request to determine a set of request attribute values;
comparing the set of request attribute values to a plurality of campaigns, each campaign including a plurality of campaign filter values; and
selecting one or more of the campaigns based on comparing the set of request attribute values to the plurality of campaigns;
wherein the first redirect resource is associated with the one or more selected campaigns.

15. A computer-implemented method according to claim 11, wherein the set of request attribute values includes at least one domain attribute value, at least one geographic attribute value and at least one visitor attribute value.

16. One or more processor readable storage devices having processor readable code embodied on the one or more processor readable storage devices, the processor readable code for programming one or more processors to perform a method for directing network traffic, the method comprising:
receiving from a first application at a client device a first network request associated with acquisition of a second application, the first network request being received at a first server;
providing a unique identifier to the client device and redirecting the client device to a second server in response to the network request, the second server providing access to the second application;
receiving from the second application at the client device a second network request associated with acquisition of the second application, the second network request being received at the first server;
determining if the second network request includes the unique identifier in response to the second network request; and
providing a resource locator having a handler associated with the second application in response to the second network request.

17. One or more processor readable storage devices according to claim 16, wherein the first network request is associated with a first domain name in a set of aggregated domain names, wherein the method further comprises:
determining a set of request attribute values for the first network request;
comparing the set of request attribute values to a plurality of campaigns, each campaign including a set of campaign filter values;
selecting a first campaign based on comparing the set of request attribute values to the plurality of campaigns, the first campaign including a redirect resource associated with the second application;
wherein redirecting the client device to the second server is performed in response to the redirect resource of the first campaign.

18. One or more processor readable storage devices according to claim 17, wherein the method further comprises:
in response to determining that the second network request includes the unique identifier, storing an indication that the redirect resource of the first campaign resulted in acquisition of the second application.

19. One or more processor readable storage devices according to claim 16, wherein the second application includes instructions that cause the client device to issue the second network request upon a first execution of the second application at the client device.

20. One or more processor readable storage devices according to claim 14, wherein the second server hosts an application store enabling purchase of the second application.
